(19) United States
(12) Patent Application Publication
(10) Pub. No.: US 2026/0133336 A1
(43) Pub. Date: May 14, 2026

(54) SYSTEM AND METHOD FOR DECONVOLUTION OF IN-WELL DISTRIBUTED ACOUSTIC SENSING

(71) Applicant: ConocoPhillips Company, Houston, TX (US)

(72) Inventors: Herbert Swan, Houston, TX (US); Kyle Friehauf, Houston, TX (US)

(21) Appl. No.: 19/384,541

(22) Filed: Nov. 10, 2025

Related U.S. Application Data
(60) Provisional application No. 63/718,131, filed on Nov. 8, 2024.

(51) Int. Cl. G01V 1/50; G01V 1/22

(52) U.S. Cl. CPC G01V 1/50; G01V 1/226; G01V 2210/38; G01V 2210/66

(57) ABSTRACT

Disclosed are systems and methods for optimizing natural resource production. The system includes a data input system configured to receive input data from one or more channels of a data transmission cable. The wellbore data includes one or more noise patterns corresponding to one or more perforations in a well casing of a wellbore. The system further includes an analysis system configured to determine one or more cluster amplitudes corresponding to each of the one or more noise patterns and generate, using the one or more cluster amplitudes, a flow distribution model. The system also includes an output generation system configured to output the flow distribution model corresponding to the one or more perforation clusters.

### CROSS-REFERENCE TO RELATED APPLICATIONS

The present application claims priority to U.S. Provisional Patent Application No. 63/718,131 filed on Nov. 8, 2024, which is incorporated by reference in its entirety herein.

### TECHNICAL FIELD

Various implementations described herein generally relate to optimizing natural resource production. More specifically, aspects of the present disclosure relate generally to systems and methods for deconvolution of in-well distributed acoustic sensing (DAS) in oil and gas recovery operations.

### BACKGROUND

Logging surveys are used in oil and gas recovery operations to determine fluid fraction and fluid flow rates of existing and potential wells. However, it can be difficult to accurately estimate and model fluid fractions using these surveys. Wells are completed by isolating relatively short segments of the well, known as stages, from each other while forcing fluid through perforation clusters within the stage. Existing methods of evaluating fluid overestimate the uniformity of flow through perforation clusters, particularly when the perforation clusters are closely spaced. It is with these observations in mind, among others, that various aspects of the present disclosure were conceived and developed.

### BRIEF SUMMARY OF THE DISCLOSURE

Implementations described and claimed herein address the foregoing problems by providing systems and methods for DAS signal processing. The systems and methods described herein allow for accurate analysis of fluid flow for optimizing natural resource production.

In one implementation, a system includes a data input configured to receive input data from one or more channels of a data transmission cable. The wellbore data includes one or more noise patterns corresponding to one or more perforation clusters in a well casing of a wellbore. The system further includes an analysis system configured to determine one or more cluster amplitudes corresponding to each of the one or more noise patterns and generate, using the one or more cluster amplitudes, a flow distribution model. The system also includes an output generation system configured to output the flow distribution model corresponding to the one or more perforation clusters.

In some implementations, a method is described. The method includes receiving, input data from one or more channels of a data transmission cable, wherein the input data includes one or more noise patterns corresponding to one or more perforation clusters in a well casing of a wellbore, determining, by a computing device including at least one processor, one or more cluster amplitudes corresponding to each of the one or more noise patterns, and generating, using the one or more cluster amplitudes, a flow distribution model corresponding to the one or more perforation clusters. Other implementations are also described and recited herein. Further, while multiple implementations are disclosed, still other implementations of the presently disclosed technology will become apparent to those skilled in the art from the following detailed description.

### BRIEF DESCRIPTION OF THE DRAWINGS

The foregoing summary, as well as the following detailed description, will be better understood when read in conjunction with the appended drawings. For the purpose of illustration, there is shown in the drawings certain examples of the presently disclosed technology. It should be understood, however, that the presently disclosed technology is not limited to the precise examples and features shown. The presently disclosed technology is capable of modifications in various aspects, all without departing from the spirit and scope of the presently disclosed technology. Accordingly, the drawings and detailed description are to be regarded as illustrative in nature and not limiting. The accompanying drawings, which are incorporated in and constitute a part of this specification, illustrate implementations of apparatuses consistent with the presently disclosed technology and, together with the description, serves to explain advantages and principles consistent with the presently disclosed technology, in which:

FIG. 1 illustrates an example system for measuring fluid flow through a wellbore;

FIG. 2 illustrates an example DAS system;

FIG. 3 illustrates an example DAS system in a wellbore;

FIG. 4 illustrates a workflow for measuring and modeling fluid flow through the wellbore; and

FIG. 5 an example computing system that may implement various aspects of the system of FIG. 1.

### DETAILED DESCRIPTION

The present disclosure involves systems and methods for optimizing natural resource production, including an effective method accounting for the spacing of perforation clusters using distributed acoustic sensing (DAS). The fluid flow analysis helps to optimize and/or determine the functionality of an existing well site or may be utilized when planning and/or optimizing a new well site. Accordingly, the presently disclosed technology reliably, efficiently, and accurately evaluates fluid flow. Other advantages will be apparent from the present disclosure.

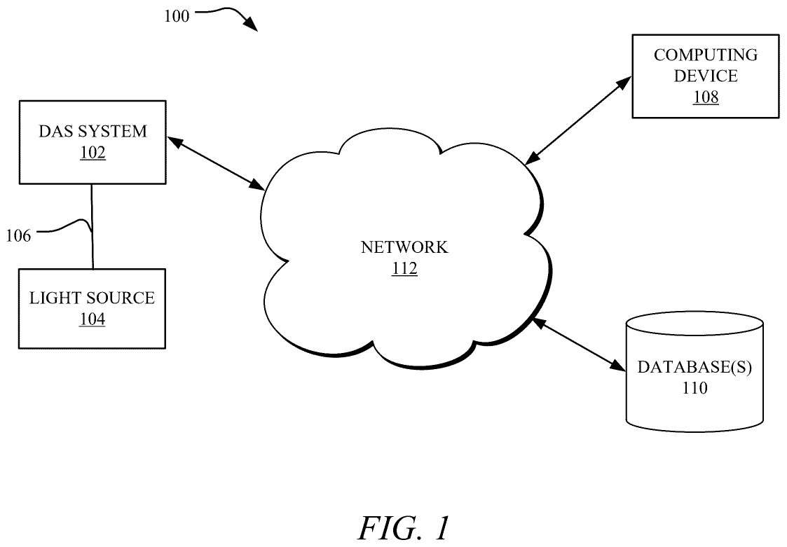

To begin the detailed description, an example system 100 is shown in FIG. 1. The system 100 can include a DAS system 102 which is connected to a light source 104 by a data transmission cable 106. The DAS system may further be in communication with a computing device 108 and/or a database 110 via a network 112. As illustrated in greater detail below, any and/or all of the DAS system 102, the computing device 108, and the one or more databases 110 may, in some instances, be special-purpose computing devices configured to perform specific functions. The computing device 108 can be a smartphone, a tablet, a desktop computer, a laptop computer, or other personal computing device.

The light source 104 is an interrogator, such as a laser. The data transmission cable 106 may be a fiber optic cable capable of transmitting light from the light source 104. The light source 104 emits light at one end of the data transmission cable 106 and the DAS system 102 is configured to receive the light as input data and analyzes the corresponding changes to the light passing through the data transmission cable 106 to determine characteristics related to the fluid flow (fluid velocity, fluid rate, etc.). The light source 104 emits light at one end, and the backscatter returns to the input end where it can be input as input data and analyzed by the DAS system 102. In an implementation, the DAS system 102 utilizes an analysis of Rayleigh scatter distribution along the data transmission cable 106, such as a fiber optic cable, to estimate fluid fractions. For example, a laser pulse is sent along the data transmission cable 106 and a backscatter is produced, which is inputted to the DAS system 102. The backscatter can be analyzed to determine acoustic events occurring in real-time along the length of the data transmission cable 106. The analysis is described in detail below.

The network(s) 112 can be any combination of one or more of a cellular network such as a 3rd Generation Partnership Project (3GPP) network, a third generation (3G) network, a fourth generation (4G) network, a fifth generation (5G) network, a Long-Term Evolution (LTE), an LTE Advanced Network, a Global System for Mobile Communications (GSM) network, a Universal Mobile Telecommunications System (UMTS) network, and the like. Moreover, the network(s) 112 can include any type of network, such as the Internet, an intranet, a Virtual Private Network (VPN), a Voice over Internet Protocol (VoIP) network, a wireless network (e.g., Bluetooth), a cellular network, a satellite network, combinations thereof, etc. The network(s) 112 can include communications network components such as, but not limited to gateways routers, servers, and registrars, which enable communication across the network(s) 112. In one implementation, the communications network components include multiple ingress/egress routers, which may have one or more ports, in communication with the network(s) 112.

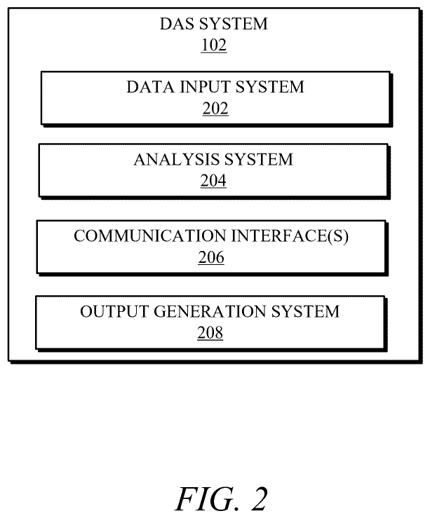

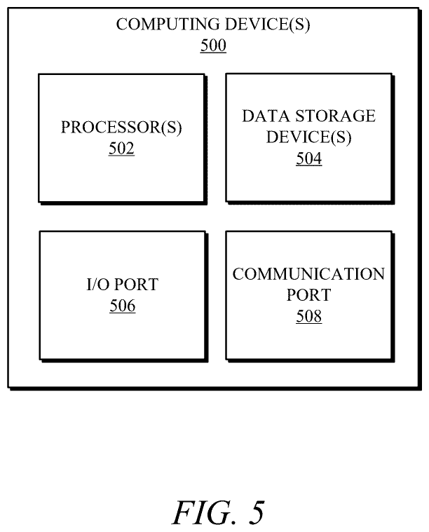

FIG. 2 depicts the DAS system 102 in greater detail. The DAS system 102 system includes a data input system 202, an analysis system 204, a communication interface 206, and an output generation system 208. The DAS system 102 may be a computing device, as described below and as depicted in FIG. 5. The data input system 202 receives the input data, such as, for example, backscatter produced in the data transmission cable 106. The received input data is then analyzed by the analysis system 204 to produce a model of the fluid flow of the wellbore along which the data transmission cable 106 is installed. This analysis will be described in further detail below. The output generation system 208 is configured to generate a notification regarding the analysis and/or optimization of the natural resource production system and/or the model of the fluid flow. For instance, the notification is audio, visual, and/or textual notification. In an implementation, the notification indicates a plot of the data for the natural resource production systems. In an implementation, the notification may be sent upon request and/or periodically to the computing device 108, such as, for example, a report in an e-mail. For instance, the notification may be sent, hourly, daily, weekly, monthly, etc. In another implementation, the notification indicates that one or more production systems require action. In an implementation, the notification is presented via one or more interactive user interfaces generated by the output generation system 208. The communication interface 206 may transmit the data output to another device, such as the computing device 108, via the network 112 for display or further processing.

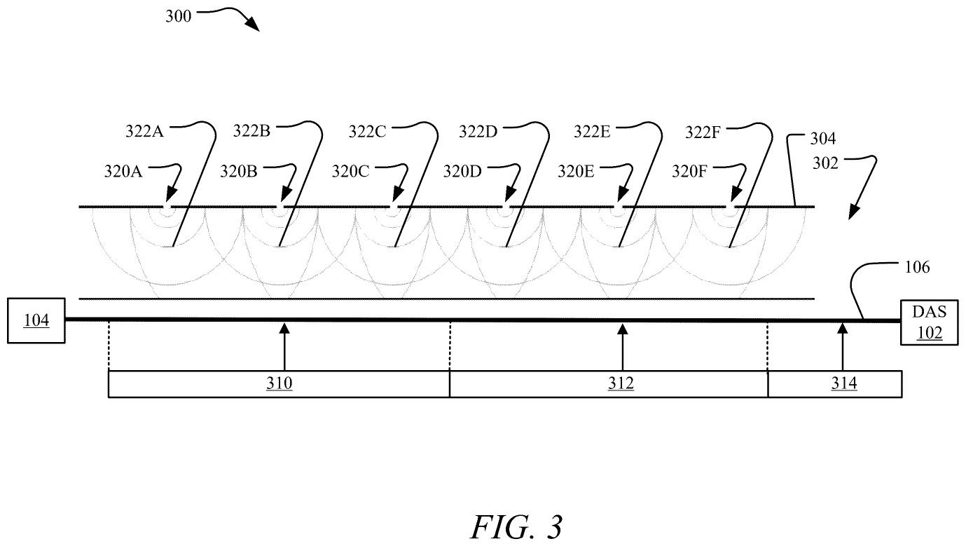

FIG. 3 depicts the DAS system 102 disposed in a wellbore 302 that includes a well casing 304. The DAS system 102, the light source 104, and the data transmission cable 106, as depicted in FIG. 1, are shown installed along a length of the wellbore 302. A depth of the wellbore 302 can range from a few feet to over a mile into the ground and can extend in one or more directions. In the present example, a horizonal wellbore is shown, however, it is contemplated that these concepts could also apply to a vertical wellbore. The data transmission cable 106 is shown extending parallel and longitudinally along the wellbore 302. The data transmission cable 106 may be permanently installed outside the well casing 304.

The data transmission cable 106 includes channels 310, 312, 314 which correspond to locations along the data transmission cable 106. A plurality of perforation clusters 320A-320F are shown along one side of the well casing 304. Six perforation clusters are shown in the present example, but any number of perforation clusters may be included. A plurality of noise patterns 322A-322F are shown associated with each of the plurality of perforation clusters 320A-320F.

The noise pattern coming from each perforation cluster is related to the rate of fluid flow through the perforation cluster. The greater the flow rate, the greater the noise level will be. The rate of flow through the cluster is proportional to the root-mean-squared (rms) intensity of the DAS signal, averaged over a broad band of frequencies. Since the sound is broadband and uncorrelated from cluster to cluster, then the squared-rms (or mean-squared) intensities of the signals from the different channels will combine linearly when they arrive at a channel of the data transmission cable 106. Moreover, the noise is bidirectional. Thus, an equal amount of the noise travels towards the toe of the well and the heel of the well.

In some instances, the rms intensity of the noise generated by fluid flow through a single cluster is roughly proportional to the fluid flow rate. However, each channel of the data transmission cable 106 responds to not just a single cluster, but to multiple ones. Since the noise emanating from the clusters is uncorrelated and statistically independent from each other, the total noise recorded by each channel of the data transmission cable 106 is a linear combination of the mean-squared intensities from all the nearby clusters. A system of equations can be written that shows the total mean-squared noise received from all the clusters at every DAS channel. The particular flow distribution can then be solved by minimizing the total squared difference between the modeled DAS response and the measured one. This procedure is a form of deconvolution.

The input data received at the DAS system 102 can be analyzed by the analysis system 204 of the DAS system 102 to generate a corresponding fluid flow model. The resulting fluid flow model may be used for optimizing and/or evaluating an existing well or optimizing and/or planning a new well.

A(i) is defined to be the mean-squared (ms) amplitude of the noise emanating from cluster i, the square root of which is also assumed to be proportional to its flow rate. The contribution of cluster i to DAS channel k is P(k, i)A(i), where P(k, i) is a propagation function which describes how strong a unit-amplitude noise from cluster i is received at channel k. This propagation function may be any well-defined function for the inversion procedure (to be defined) to work. However, the present implementation of the method takes P(k, i) to be Gaussian of the form:

$$P ( k , i ) = \frac{1}{σ ( i ) \sqrt{2 π}} exp [ \frac{- {Δ}^{2} ( k , i )}{{σ}^{2} ( i )} ] \qquad ( 1 )$$

where Δ(k, i)=D(i)−d(k). D(i) is the measured depth along the wellbore to cluster i, and d(k) is the measured depth to the midpoint of DAS channel k. According to this equation, the noise power from any cluster spreads out as a Gaussian function, with σ(i) is the standard deviation (width) of that Gaussian distribution. Different clusters have different noise widths, which are obtained from the inversion procedure.

The total modeled response at channel k from all of the clusters is obtained by summing their rms amplitudes:

$$M ( k ) = {\sum }_{i = 0}^{n - 1} P ( k , i ) A ( i ) , \qquad ( 2 )$$

where n is the number of clusters in the stage. The modeled error at channel k is given by:

$$E ( i ) = x ( k ) - M ( k ) , \qquad ( 3 )$$

where x(k) is the rms DAS intensity measured at channel k. The total modeled error from all of the channels is given by:

$${ϵ}^{2} = {\sum }_{k = 0}^{m - 1} {E}^{2} ( k ) = {{\sum }_{k = 0}^{m - 1} [ x ( k ) - {\sum }_{i = 0}^{n - 1} P ( k , i ) A ( o = i ) ]}^{2} , \qquad ( 4 )$$

where m is the number of channels, and where it is assumed that m≥n.

In order to minimize the total modeling error ϵ², we must find cluster intensities Â(j) which cause the derivative of Equation (4) with respect to A(j) to be zero at every cluster 0≤j<n. The application of the usual differentiation formulas:

$$\frac{{dϵ}^{2}}{dA ( j )} {\vert}_{A ( j ) = \hat{A} ( j )} = - 2 {\sum }_{k = 0}^{m - 1} [ x ( k ) - {\sum }_{i - 0}^{n - 1} P ( k , i ) \hat{A} ( i ) ] P ( k , j ) = 0. \qquad ( 5 )$$

This condition requires that:

$${\sum }_{k = 0}^{m - 1} P ( k , j ) x ( k ) = {\sum }_{k = 0}^{m - 1} P ( k , j ) {\sum }_{i = 0}^{n - 1} P ( k , i ) \hat{A} ( i ) . \qquad ( 6 )$$

Exchanging the order of summation leads to the so-called normal equations of deconvolution:

$${\sum }_{k = 0}^{m - 1} P ( k , j ) x ( k ) = {\sum }_{i = 0}^{n - 1} \hat{A} ( i ) {\sum }_{k = 0}^{m - 1} P ( k , i ) P ( k , j ) . \qquad ( 7 )$$

These equations can be written in matrix form for computational purposes.

$$B ( i , j ) = {\sum }_{k = 0}^{m - 1} P ( k , i ) P ( k , j ) and C ( j ) = {\sum }_{k = 0}^{m - 1} P ( k , j ) x ( k ) \qquad ( 8 )$$

then for three clusters,

$$[ \begin{matrix}B ( 0 , 0 ) & B ( 0 , 1 ) & B ( 0 , 2 ) \\ B ( 1 , 0 ) & B ( 1 , 1 ) & B ( 1 , 2 ) \\ B ( 2 , 0 ) & B ( 2 , 1 ) & B ( 2 , 2 )\end{matrix} ] [ \begin{matrix}\hat{A} ( 0 ) \\ \hat{A} ( 1 ) \\ \hat{A} ( 2 )\end{matrix} ] = [ \begin{matrix}C ( 0 ) \\ C ( 1 ) \\ C ( 2 )\end{matrix} ] \qquad ( 9 )$$

B is an n×n symmetric matrix [since B(ij)=Bj,i)], and \vec{C} is an n×1 vector. The n×1 vector Â represents the optimized rms amplitudes of the noise generated from each of the cluster. It is the desired output of the analysis.

The propagation function P(k,i) can also be written as an m×n matrix. For a system with 3 clusters and 4 channels, the propagation matrix becomes

$$P = [ \begin{matrix}P ( 0 , 0 ) & P ( 0 , 1 ) & P ( 0 , 2 ) \\ P ( 1 , 0 ) & P ( 1 , 1 ) & P ( 1 , 2 ) \\ P ( 2 , 0 ) & P ( 2 , 1 ) & P ( 2 , 2 ) \\ P ( 3 , 0 ) & P ( 3 , 1 ) & P ( 3 , 2 )\end{matrix} ] \qquad ( 10 )$$

Using the definitions of B and C from Equation (8) and the definitions of matrix multiplication, B=P^{T}P and \vec{C}=P^{T} \vec{x}, where \vec{x} is the m×1 vector of channel intensities. The normal equations of Equation (9) then become:

$${P}^{T} P \hat{A} = {P}^{T} \vec{x} , \qquad ( 11 )$$

The solution to the problem of minimizing the total modeling error of Equation (4) is therefore found by pre-multiplying Equation (11) by (P^{T}P)⁻¹:

$$\hat{A} = {( {P}^{T} P )}^{- 1} {P}^{T} \vec{x} . \qquad ( 12 )$$

The result is a non-iterative way to find the optimal combination of noise amplitudes (as well as their corresponding flow rates) which most closely matches the modeled total noise amplitudes measured from the DAS channels, assuming a fixed set of noise widths. It is a fast and efficient way to solve the problem, given the relatively small number of clusters and channels per stage.

An even better agreement can be obtained between the modeled and measured DAS intensities by further optimizing the noise widths. As described in above, E(k) of Equation (3) is the discrepancy between the modeled noise amplitude at DAS channel k and its measured amplitude, based on a purported amount of noise coming from each of the clusters, A(i), 0≤i<n, and assuming that this noise spreads out from cluster i according to a Gaussian distribution, Equation (1), of width a(i). This equation can be expressed in matrix form as follows:

$$\vec{E} ( \vec{σ} ) = \vec{x} - P \vec{A} , \qquad ( 13 )$$

where \vec{E}(\vec{σ}) is the m×1 vector of channel discrepancies E(k), which is a function of the n×1 vector of cluster noise widths \vec{σ}, and where \vec{A} is the n×1 vector of cluster amplitudes A(i). P is an implicit function of \vec{σ} via Equation (1). The cluster amplitudes \vec{A} are set to their optimized values, Â, the optimized channel discrepancies become

$$\hat{E} ( \vec{σ} ) = \vec{x} - P \vec{A} = \vec{x} - {P ( {P}^{T} P )}^{- 1} {P}^{T} \vec{x} . \qquad ( 14 )$$

The total squared model-versus-measured noise discrepancy over all of the channels is represented by the symbol ϵ², and is defined by Equation (4). By inserting the values of the optimized cluster amplitudes obtained from the columns of Equation (12) into Equation (4), the smallest possible total squared discrepancy between modeled and measured channel amplitudes for any alleged distribution of cluster noises is obtained, assuming the noises disperse according to width vector \vec{σ}:

$${\hat{ϵ}}^{2} ( \vec{σ} ) = {\hat{E}}^{T} ( \vec{σ} ) \hat{E} ( \vec{σ} ) = {( \vec{x} - P \vec{A} )}^{T} ( \vec{x} - P \vec{A} ) = {\vec{x}}^{T} \vec{x} - {( P \hat{A} )}^{T} \vec{x} , \qquad ( 15 )$$

where Â is found from Equation (12).

The derivative of ê² can be set with respect to each of the members of \vec{σ} to zero and solve the resulting set of equations. However, these equations will be nonlinear, and a non-iterative solution may be unobtainable. Therefore, an iterative approach can be used. The methods of steepest descent and conjugate gradient have been extensively studied and are well understood for linear optimization problems, where the error function is a parabolic bowl. However, these methods may suffer serious difficulties for nonlinear problems, where the error function is nonparabolic. The following iterative procedure has been tested for the current problem, and converges adequately well.
1. Set all σ's to an initial constant value, and assign an initial step size for scanning. (In the numerical examples shown, the initial value of the σ's was set to 5 ft, and the initial step size was set to 0.1 ft.)
2. Scan over a range of a's, varying the width of each cluster in unison to be the same as for all the other clusters.
3. Scan each cluster width individually, keeping the widths of the other cluster the same as they were previously.
4. Repeat step 3, decreasing the step size until convergence is achieved.

The term “scan” refers to the process of repeatedly evaluating Equation (15) using a collection of cluster width combinations. There are two types of scans that could be used:

Complete scan: The scan is performed over a complete pre-determined range of values, incrementing the values by a fixed step size at each iteration. This type of scan does not stop until every trial value of the parameter(s) being varied is tried. The result of the scan is that width vector \vec{σ} which minimizes Equation (15).

Partial scan: The scan is first performed using positive multiples of the step size, and continues until either the limit of the scan range is achieved, or until the iteration no longer decreases \hat{∈}², whichever comes first. If no decrease of \hat{∈}² is achieved in the positive direction, the scan is repeated using negative increments of the step increment.

The complete scan method requires more iterations but is more immune to local minima. The partial scan method requires fewer iterations to converge but is susceptible to local minima. Local minima are not a significant problem, so that partial scans can be safely used.

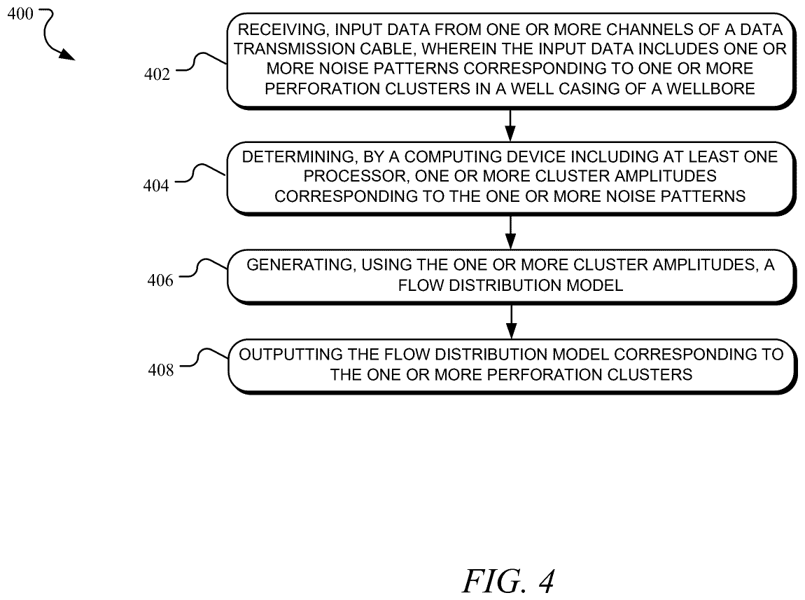

FIG. 4 depicts a workflow 400 for optimizing natural resource production, which can be performed by systems 100 or 300 discussed herein. The method 400 can, in some instances, occur in real time.

At operation 402, input data is received from one or more channels of a data transmission cable, wherein the input data includes one or more noise patterns corresponding to one or more perforation clusters in a well casing of a wellbore. As described above, the input data is received by the data input system 202 of the DAS system 102. At operation 404, one or more cluster amplitudes corresponding to each of the one or more noise patterns are determined. In an implementation, the cluster amplitudes are calculated by the analysis system 204 of the DAS system 102. At operation 406, a flow distribution model is generated using the one or more cluster amplitudes, and at operation 408, the flow distribution model is output. In an implementation, the flow distribution is output by the output generation system 208 of the DAS system 102.

It is to be understood that the specific order or hierarchy of steps in the method depicted in FIG. 4 is an instance of an example approaches and can be rearranged while remaining within the disclosed subject matter. For instance, any of the steps depicted in FIG. 4 may be omitted, repeated, performed in parallel, performed in a different order, and/or combined with any other of the steps depicted in FIG. 4. Any accompanying method claims thus present elements of the various steps in a sample order and are not necessarily meant to be limited to the specific order or hierarchy presented unless explicitly stated.

FIG. 5 illustrates a computing device 500, which may be used to carry out the system and method described herein. The computing device 500 includes a processor 502, a data storage device 504 (e.g., hardware memory), an I/O port 506, and a communication port 508. It will be appreciated that other non-transitory tangible computer-readable storage media storing computer-executable instructions for implementing the presently disclosed technology on a computing system may be used. In the present disclosure, the methods and operations disclosed herein may be implemented as sets of instructions or software readable by a device. These sets of instructions can convert the computing device 500 into a special purpose device for measuring and modeling fluid flow (e.g., a new type of file). As such, the computing device 500 can integrate the system described herein into a practical application by providing an accurate visualization of fluid flow within a wellbore, thus improving the technological field of wellbore modeling software for the oil/gas industry.

In some instances, the system described herein may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium, optical storage medium; magneto-optical storage medium, read only memory (ROM); random access memory (RAM); erasable programmable memory (e.g., EPROM and EEPROM); flash memory; or other types of medium suitable for storing electronic instructions.

The instructions, media for conveying such instructions, computing resources for executing them, and other structures for supporting such computing resources can be means for providing the functions described in these disclosures.

In the description, phraseology and terminology are employed for the purpose of description and should not be regarded as limiting. For example, the use of a singular term, such as “a”, is not intended as limiting of the number of items. Also, the use of relational terms such as, but not limited to, “down” and “up” or “downstream” and “upstream”, are used in the description for clarity in specific reference to the figures and are not intended to limit the scope of the presently disclosed technology or the appended claims. Further, any one of the features of the presently disclosed technology may be used separately or in combination with any other feature. For example, references to the term “implementation” means that the feature or features being referred to are included in at least one aspect of the presently disclosed technology. Separate references to the term “implementation” in this description do not necessarily refer to the same implementation and are also not mutually exclusive unless so stated and/or except as will be readily apparent to those skilled in the art from the description. For example, a feature, structure, process, step, action, or the like described in one implementation may also be included in other implementations but is not necessarily included. Thus, the presently disclosed technology may include a variety of combinations and/or integrations of the implementations described herein. Additionally, all aspects of the presently disclosed technology as described herein are not essential for its practice.

Lastly, the terms “or” and “and/or” as used herein are to be interpreted as inclusive or meaning any one or any combination. Therefore, “A, B or C” or “A, B and/or C” mean any of the following: “A”; “B”; “C”; “A and B”; “A and C”; “B and C”; or “A, B and C.” An exception to this definition will occur only when a combination of elements, functions, steps or acts are in some way inherently mutually exclusive.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined in blocks differently in various implementations of the disclosure or described with different terminology. These and other variations, modifications, additions, and improvements may fall within the scope of the disclosure as defined in the claims that follow.

What is claimed is:

1. A system to optimize natural resource production, comprising:
a data input system configured to receive input data from one or more channels of a data transmission cable, wherein the input data includes one or more noise patterns corresponding to one or more perforation clusters in a well casing of a wellbore;
an analysis system configured to determine one or more cluster amplitudes corresponding to each of the one or more noise patterns and generate a flow distribution model, the analysis system generating the flow distribution model using the one or more cluster amplitudes; and
an output generation system configured to output the flow distribution model corresponding to the one or more perforation clusters.

2. The system of claim 1, wherein each of the one or more channels is influenced by one or more of the one or more perforation clusters.

3. The system of claim 1, wherein each of the one or more perforation clusters corresponds to one of the one or more noise patterns.

4. The system of claim 1, wherein each of the one or more cluster amplitudes correlates to a distance between perforation clusters.

5. The system of claim 1, wherein a rate of flow through each of the one or more perforation clusters is proportional to a root-mean-square (rms) intensity of the input data.

6. The system of claim 1, wherein the one or more noise patterns are bidirectional.

7. The system of claim 1, wherein the data transmission cable is a fiber optic cable that utilizes distributed acoustic sensing (DAS).

8. The system of claim 1, wherein the data transmission cable is permanently installed outside of the well casing.

9. The system of claim 1, wherein the data transmission cable is installed longitudinally along the wellbore.

10. The system of claim 1, wherein the wellbore is a horizontal wellbore.

11. A method for optimizing natural resource production, the method comprising:
sensing input data including one or more noise patterns corresponding to one or more perforation clusters in a well casing of a wellbore, the input data sensed via one or more channels of a data transmission cable;
determining one or more cluster amplitudes corresponding to the one or more noise patterns, the one or more cluster amplitudes determined at least one processor;
generating a flow distribution model using the one or more cluster amplitudes; and
outputting the flow distribution model to a display of a computing device, the flow distribution model corresponding to the one or more perforation clusters.

12. The method of claim 11, wherein each of the one or more channels is influenced by one or more of the one or more perforation clusters.

13. The method of claim 11, wherein each of the one or more perforation clusters corresponds to one of the one or more noise patterns.

14. The method of claim 11, wherein each of the one or more cluster amplitudes correlate to a distance between the one or more perforation clusters.

15. The method of claim 11, wherein a rate of flow through each of the one or more perforation clusters is proportional to a root-mean-square (rms) intensity of the input data.

16. The method of claim 11, wherein the one or more noise patterns are bidirectional.

17. The method of claim 11, wherein the data transmission cable is a fiber optic cable that utilizes distributed acoustic sensing (DAS).

18. The method of claim 11, wherein the data transmission cable is permanently installed outside of the well casing.

19. The method of claim 11, wherein the data transmission cable is installed longitudinally along the wellbore.

20. One or more tangible non-transitory computer-readable storage media storing computer-executable instructions for performing a computer process on a computing system, the computer process comprising:
receiving input data from one or more channels of a data transmission cable, wherein the input data includes one or more noise patterns corresponding to one or more perforation clusters in a well casing of a wellbore;
determining one or more cluster amplitudes corresponding to the one or more noise patterns;
generating, using the one or more cluster amplitudes, a flow distribution model; and
outputting the flow distribution model to a display of the computing system the flow distribution model corresponding to the one or more perforation clusters.
